(19) United States
(12) Patent Application Publication
(10) Pub. No.: US 2013/0338974 A1
(43) Pub. Date: Dec. 19, 2013

(54) SYSTEM AND METHOD FOR EFFICIENTLY IMPORTING OBJECTS INTO A COMPUTER-AIDED DESIGN PROGRAM

(71) Applicants: Kevin Kochman, Aurora, IL (US); Robert Linders, Orlando, FL (US)

(72) Inventors: Kevin Kochman, Aurora, IL (US); Robert Linders, Orlando, FL (US)

(21) Appl. No.: 13/839,248

(22) Filed: Mar. 15, 2013

Related U.S. Application Data
(60) Provisional application No. 61/660,348, filed on Jun. 15, 2012.

(51) Int. Cl. G06F 17/50

(52) U.S. Cl. CPC G06F 17/5004
USPC 703/1

(57) ABSTRACT

Disclosed are a system and method for quickly and efficiently importing digital objects into a computer-aided design (CAD) program. The system provides a database that has a compilation of digital objects collected from external sources. The digital objects may be sorted by manufacturer, category of object, file type, model number, and so on. Once an digital object is selected, several options become available depending on the file type of the object. With some file types, one of numerous types associated with a specific object may be chosen before placing the digital object into the CAD program. With other file types, the user may configure a multitude of options pertaining to the object before placing the digital object into the CAD program. The digital object may then be placed within a project in the CAD program by the single click of a button or keystroke.

### FIELD OF THE INVENTION

The present invention relates generally to computer-aided design programs and, more specifically, to a method and system for efficiently importing digital objects, including objects pertaining to kitchen design, into computer-aided design programs from a database having a compilation of objects.

### BACKGROUND OF THE INVENTION

Computer-aided design (CAD) programs have become powerful tools for engineers and others to use in designing, drafting, and modeling a variety of objects. Many CAD programs provide features that allow users to import digital objects from a source external to the CAD program, as there are many digital objects that are not available directly within the CAD program.

For example, consider an automotive supplier that makes CAD files of its patented products available on its website. Because these CAD files from the automotive supplier are not available within the CAD program, a user of the CAD program may wish to import one or more of these CAD files into a project within the CAD program.

At present, the user has to perform a number of steps before placing the particular CAD file or digital object within the user's project. First, the user may have to navigate to the automotive supplier's website and locate the particular web page at which such CAD files are available. Then, the user downloads at least one—and often two or more—files pertaining to the object to be placed within the project. The user typically downloads these files to a local hard drive or other local memory. After returning to an interface for the CAD program, the user locates and selects an “import,” “load,” or similar “button” that prompts the user to locate the necessary file or files within the local hard drive. Once selecting the appropriate files, the CAD program returns to the interface showing the project. If the digital object is part of a “family” of objects, oftentimes a “type” catalog pops up and shows the user the various objects (e.g., models) within that family. After clicking out of this pop-up, the user must further proceed to “drag and drop” the objects from a sidebar or other toolbar into the project workspace. All the while, the user typically is not shown a preview of the object being imported, thus making it more likely that the user will import the wrong object.

Moreover, this process is tedious, especially if the user wishes to import a number of objects from an external source. The laborious nature of importing objects is compounded when the user needs to import a number of objects from different external sources. Such a task requires navigating to a number of different websites to download multiple files from each website. Once the files are downloaded, the user must then repeat the import process described above for each object that the user wishes to place within a project.

Thus, there is a long felt need in the CAD field for a method and system for quickly and easily importing objects from external sources into CAD programs.

### SUMMARY OF THE INVENTION

The disclosed system and method provide a way for users of CAD programs to quickly and efficiently import digital objects. Digital objects may differ depending on the type of CAD program, but may generally include the digital replica of virtually any physical or even non-physical article. Throughout this disclosure, the term “object” is used interchangeably with “digital object”, which signifies a digital version or file of a physical object.

One aspect of the system involves a database where a multitude of files are compiled. These files represent objects to be imported into a project within the CAD program. By having objects in a central database, users do not have to navigate to a different website and download one or more files for each object they wish to import. The database may be updated routinely so that users have access to the latest objects. Even after an object is placed within a project in the CAD program, the object may be linked to the database. In this way, the user may be prompted, for example, regarding whether or not to update the object within the project when the database is updated and reflects a modification to the object according to a designer or manufacturer.

The system provides a number of ways in which a user can locate the object he or she is looking for when viewing objects within the database. For example, a manufacturer filter allows the user to view only those objects in the database that originate from a certain manufacturer. Likewise, a category filter allows the user to do the same with regard to categories of objects. Users can also sort through the database by typing all or part of a model number into a search bar. Further, users can sort the database according to file type, as objects generally come in a number of file types. Another helpful feature allows the user to preview the object before placing the object within a project.

In the CAD program used to facilitate the description of the disclosed system and method (i.e., Autodesk Revit Architecture), objects with varying Revit file types may be imported. With some Revit file types, the system and method provide the user with an option to choose a “type” (i.e., different than file type) from a “type catalog” associated with an object—before the object is ever imported. With still other file types, the system and method display a configurator before the object is imported into a project. The configurator presents the user with all of the options available for that object. The user can configure the object to be imported as desired, down to every last configurable detail.

Once the user selects the object to be imported, a primary interface for the CAD program reappears. Without having to click anything within the interface, the object is placed on a cursor when the cursor hovers within the project in the interface. With the single click of a mouse or a keystroke, the user may place the object within the project. In some embodiments, the object then disappears from the cursor. In other embodiments, the object may remain on the cursor in case the user wishes to place further quantities of the object within the project.

### BRIEF DESCRIPTION OF THE DRAWINGS

The preferred embodiments of the invention will be described in conjunction with the appended drawings, which illustrate and do not limit the invention, where like designations denote like elements, and in which:

FIG. 1 shows a new project within a user interface of the Autodesk Revit Architecture CAD program.

FIG. 2 shows an object import interface used to locate, preview, configure, and import objects for placement within the project of the user interface shown in FIG. 1.

FIG. 3 shows the object import interface of FIG. 2 with the objects in a database shown in an icon mode.

FIG. 4 shows a filter option within the object import interface of FIGS. 2-3 that allows a user to sort the objects in the database by manufacturer.

FIG. 5 shows an example of an object with an AutoCAD 2D file type within the object import interface of FIGS. 2-4.

FIG. 6 shows an example of an object with an AutoCAD 3D file type within the object import interface of FIGS. 2-5.

FIG. 7 shows an example of an object with a Revit—One Off file type within the object import interface of FIGS. 2-6.

FIG. 8 shows an example of an object with a Revit—Simple Type Catalog file type within the object import interface of FIGS. 2-7.

FIG. 9 shows how a drop-down option may selectively be used to choose a particular type of an object having the Revit—Simple Type Catalog file type.

FIG. 10 shows an example of an object with a Revit—Configurable file type within the object import interface shown in FIGS. 2-9.

FIG. 11 shows a configurator feature that allows a user to configure an object having a Revit—Configurable file type before importing the object into the project of the user interface.

FIG. 12 shows an object being placed within a project of the user interface with the single click of a button or keystroke, as the object is automatically placed on a cursor within the user interface.

FIG. 13 shows a “Quick Edit” toolbox within the user interface that allows a user to quickly change an object's type without leaving the Autodesk Revit Architecture program.

### DETAILED DESCRIPTION OF EMBODIMENTS OF THE INVENTION

The present invention generally provides a system and method for importing objects into CAD programs. For illustrative purposes only, the present invention is described in the context of the Autodesk Revit Architecture CAD program. It should be understood that Autodesk Revit Architecture is merely a vehicle for explaining the present invention and that the present invention may be implemented in a wide spectrum of CAD programs.

Also, objects may differ depending on the type of CAD program, but may generally include a rendering of virtually any physical or even non-physical article. For example, in CAD programs tailored to the automotive industry, objects may include mufflers, engine heating blocks, instrument panels, airbags, carburetors, suspension systems, gasoline tanks, bolts, and so on. In CAD programs tailored to the telecommunications industry, objects may include cell phone towers, modems, Ethernet cards, encryption algorithms, or even representations of wireless data protocols, for example. Thus, an object is essentially anything that can be represented in a CAD program.

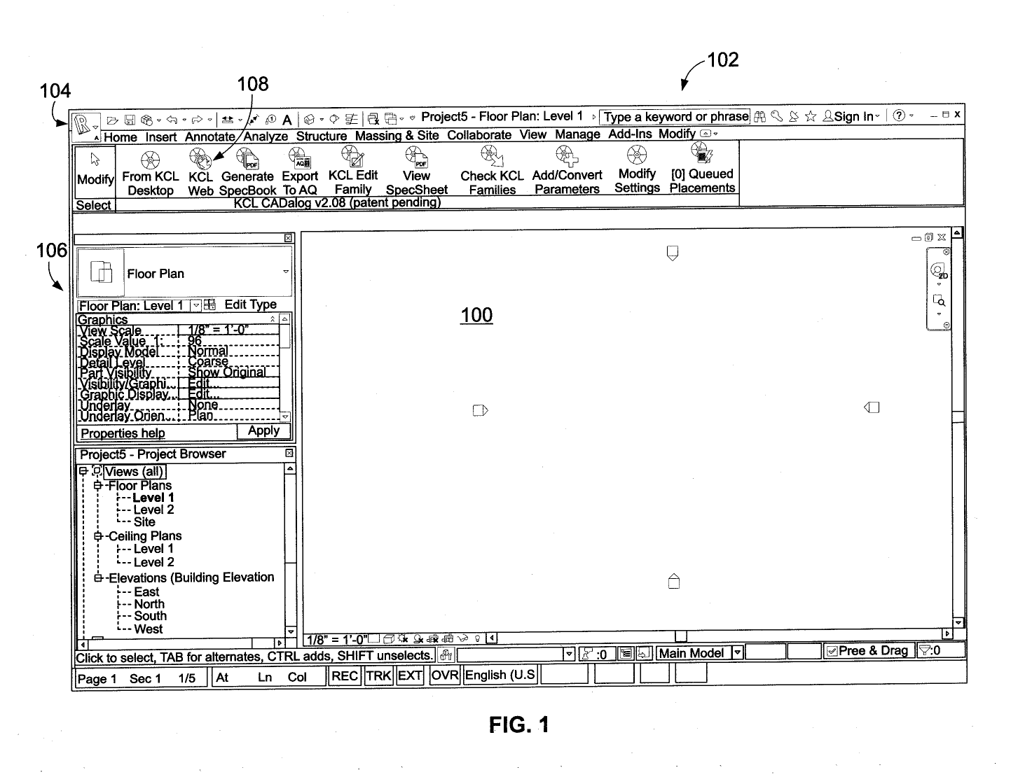

Turning to FIG. 1, a new project 100 is shown within a user interface 102 of Autodesk Revit Architecture. The user interface 102 may generally include a row of drop-down menus 104 and one or more sidebars 106, all of which provide tools that allow the user to control the Autodesk Revit Architecture CAD program.

Depending on the application, users either create objects from scratch within CAD programs or import largely pre-defined objects from other sources into CAD programs. In the latter case, users may locate an import feature 108, identified in FIG. 1 as “KCL Web,” amongst a number of features 110 available along an “Add-In” toolbar 112. Before describing the import feature 108, it should be noted that the import feature 108 need not necessarily be part of an add-in for a CAD program. In other embodiments, for example, the import feature 108 may be a tool that is configured as part of the base CAD program, rather than as a supplement.

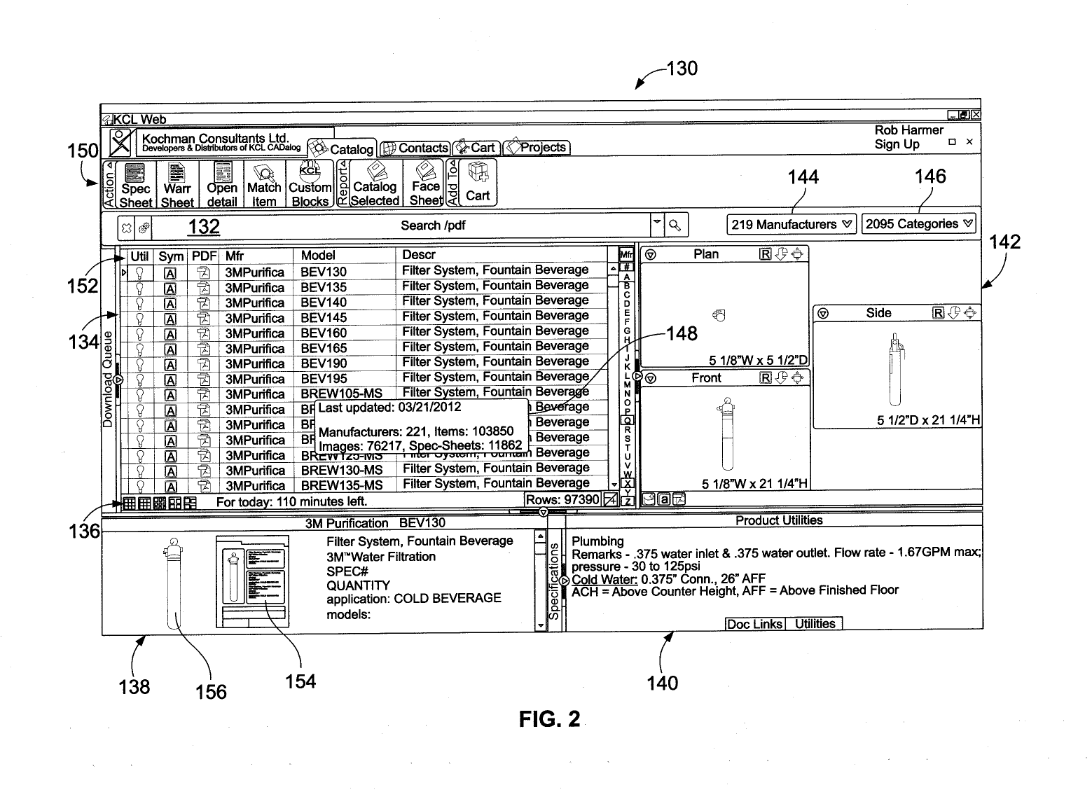

At any rate, once a user selects the import feature 108, an object import interface 130 may appear, as shown in FIG. 2. The object import interface 130 may include without limitation a search bar 132, a database 134, an assortment of viewing options 136, a product literature window 138, a specification window 140, a preview window 142, a manufacturer filter option 144, an object category filter option 146, an update indicator 148, and numerous other tools 150, for example.

The database 134 may include a compilation of old and new objects, where new objects are routinely collected from various manufacturers' websites. Thus, all objects that users of Autodesk Revit Architecture may be interested in importing are aggregated into the database 134—so that the user does not have to navigate to each manufacturer's website to download each desired object. When the user initially opens the object import interface 130, the update indicator 148 may display when the database 134 was last updated along with the number of manufacturers, objects, images, and spec-sheets currently in the database 134.

Within the object import interface 130, the objects may be sorted in a number of ways. As shown, for example, the objects are sorted by manufacturer and then by model number. By clicking one of the headers 152, the database 134 may be sorted by that category. Further, a user may type the name of a manufacturer, a model number, or other textual descriptors within the search bar 132. Based on that input, the database 134 will show objects that contain that criteria.

When an object is selected within the database 134, the product literature window 138 may show data from any available specification sheet, as these too are aggregated from the manufacturers' websites. For example, the product literature window may show an image 154 of the specification sheet and a close-up 156 of the object from the specification sheet. Any other available information about the object may be shown in the specification window 140, whether pulled from the manufacturer's website, specification sheet, or the like.

The preview window 142 within the object import interface 130 may provide the user with a number of previews of the object from different angles that are available. The previews may be generated based on how the object would appear if imported into the project, even though Autodesk Revit Architecture does not provide a preview before importing an object Thus the user will know what he or she is importing before the object is actually imported. As will be described in more detail below, the number and variety of views within the preview window 142 may depend on the type of file that is being imported. As shown in FIG. 2, however, plan, front, and side views are available based on the file type for the object selected.

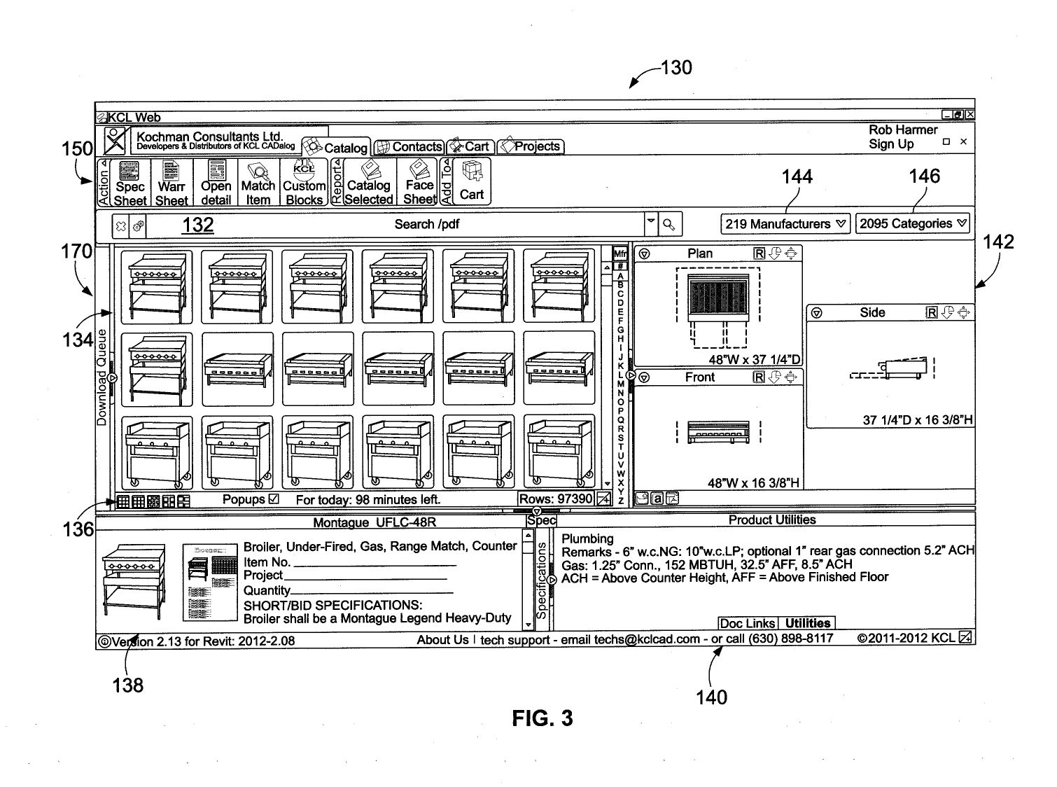

Moreover, the assortment of viewing options 136 provides alternative arrangements through which to view the objects, such as in an icon mode 170, for example, as shown in FIG. 3.

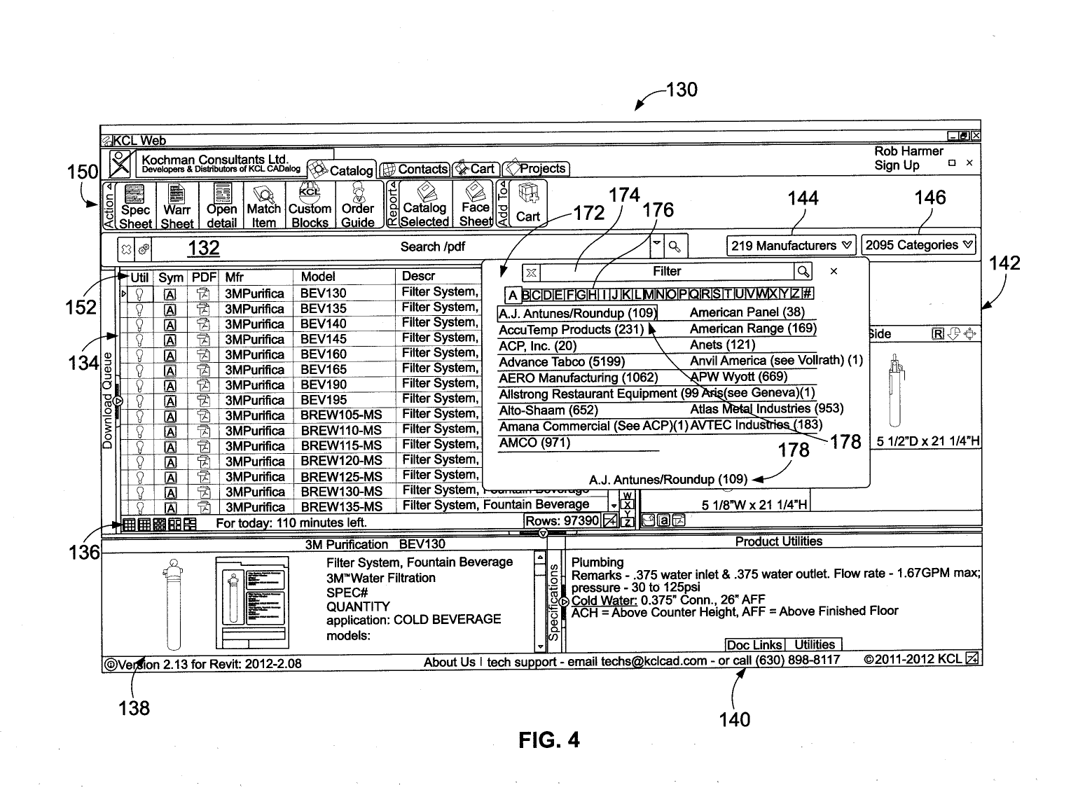

With respect to FIG. 4, still another way to sort the objects is by selecting the manufacturer filter option 144 within the object import interface 130. Thereafter, a dialog box 172 may appear with a search bar 174, which may be similar to search bar 132, an alphabetical listing 176, and at least one numerical indicator 178. By clicking one of the letters shown on the alphabetical listing 176, the dialog box 172 may show only manufacturers' names that begin with the chosen letter. As shown, the letter “A” has been selected and manufacturers beginning with “A” are shown. Also within the dialog box 172 may be several numerical indicators 178 that show the number of objects available according to each manufacturer. After selecting a particular manufacturer, the dialog box 172 may close out, and the database 134 may show only those objects from the manufacturer that was selected. Although not shown with as much detail in the figures, the object category filter option 146 may operate similarly to the manufacturer filter option 144, providing the user with another way to locate desirable objects.

As with many CAD programs, Autodesk Revit Architecture can support a number of file types. Several file types that Autodesk Revit Architecture can support include two-dimensional (2D) AutoCAD files, three-dimensional (3D) AutoCAD files, Revit—One Off files, Revit—Simple Type Catalog files, and Revit—Configurable files.

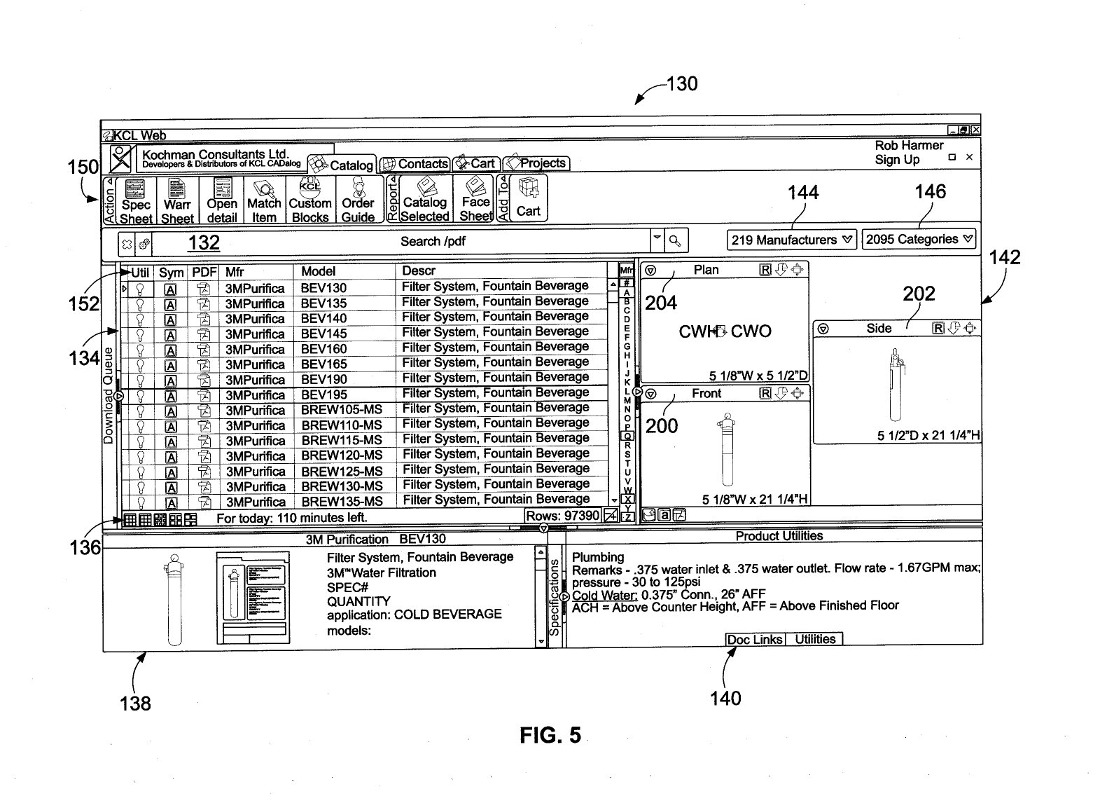

The disclosed import feature may convert AutoCAD 2D and 3D file types such that the imported objects may be viewed in Autodesk Revit Architecture. FIG. 5 shows an example of the first file type: a 2D AutoCAD file. In particular, model number BEV 130 from 3M Purification Inc. is shown, which is a cold beverage filtration system. With 2D AutoCAD files, front 200, side 202, and plan 204 views of the object are available in the preview window 142. If imported into Autodesk Revit Architecture, the object will display in level 1, south, and east views.

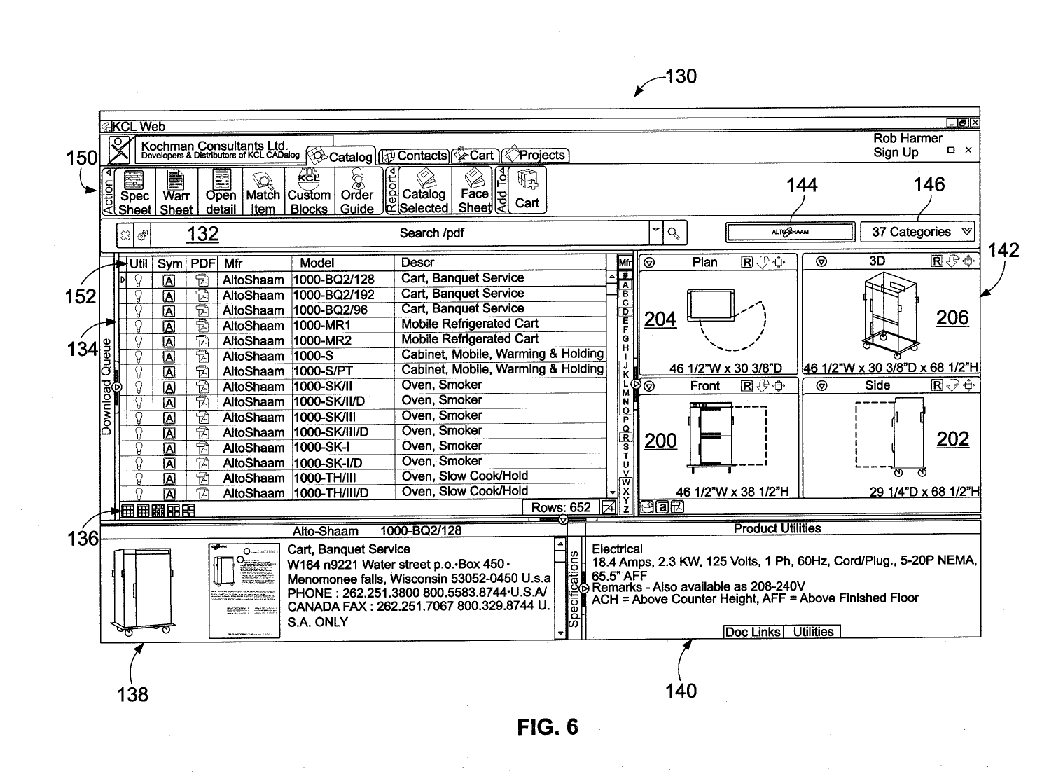

Similarly, an example of a 3D AutoCAD file is shown in FIG. 6. In particular, model number 1000-BQ2/128 by AltoShaam is shown. Here, in addition to the front 200, side 202, and plan 204 views, a three-dimensional (3D) view 206 is available in the preview window 142. When a 3D AutoCAD file such as this one is imported into Autodesk Revit Architecture, the object will display in all views.

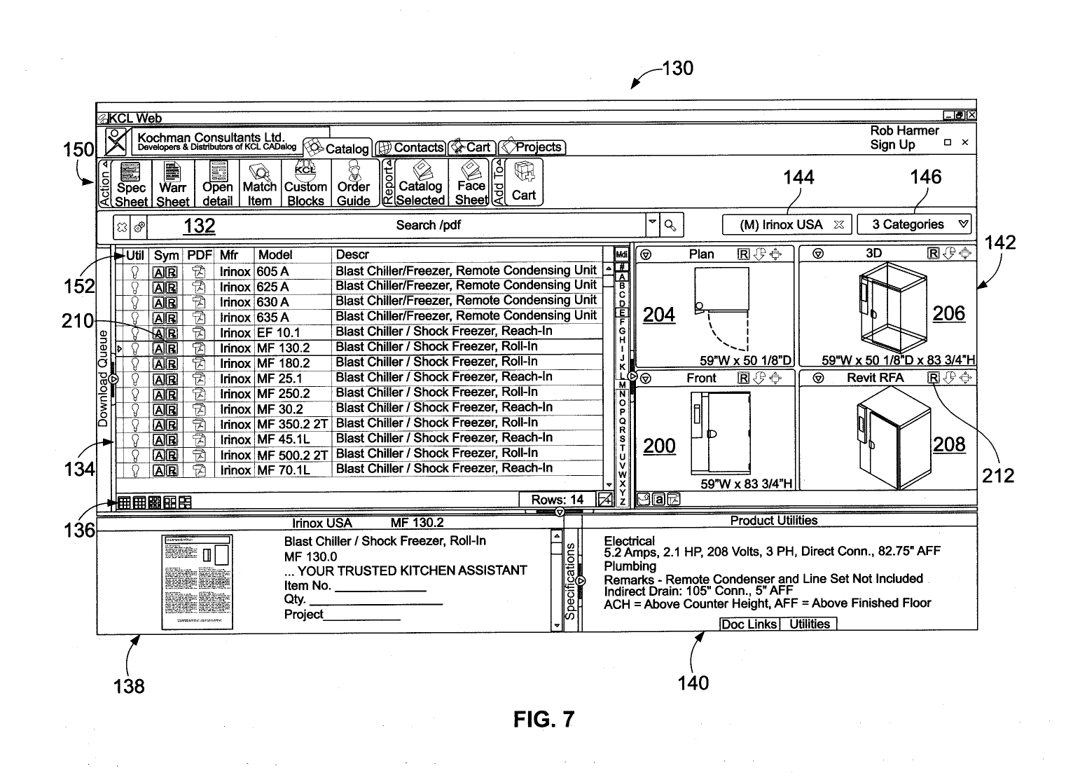

An example of the third file type, a Revit—One Off, is shown in the object import interface 130 in FIG. 7. An Irinox MF 130.2 blast chiller, in particular, is selected and shown in the preview window 142. This type of file is a native Revit file, as indicated by the Revit RFA view 208 and the “R” symbol 210. Revit—One Off file types do not have any options that can be configured. Nonetheless, to import this object or any others into the project, the user may click any “R” icons 212 shown on the different views within the preview window 142.

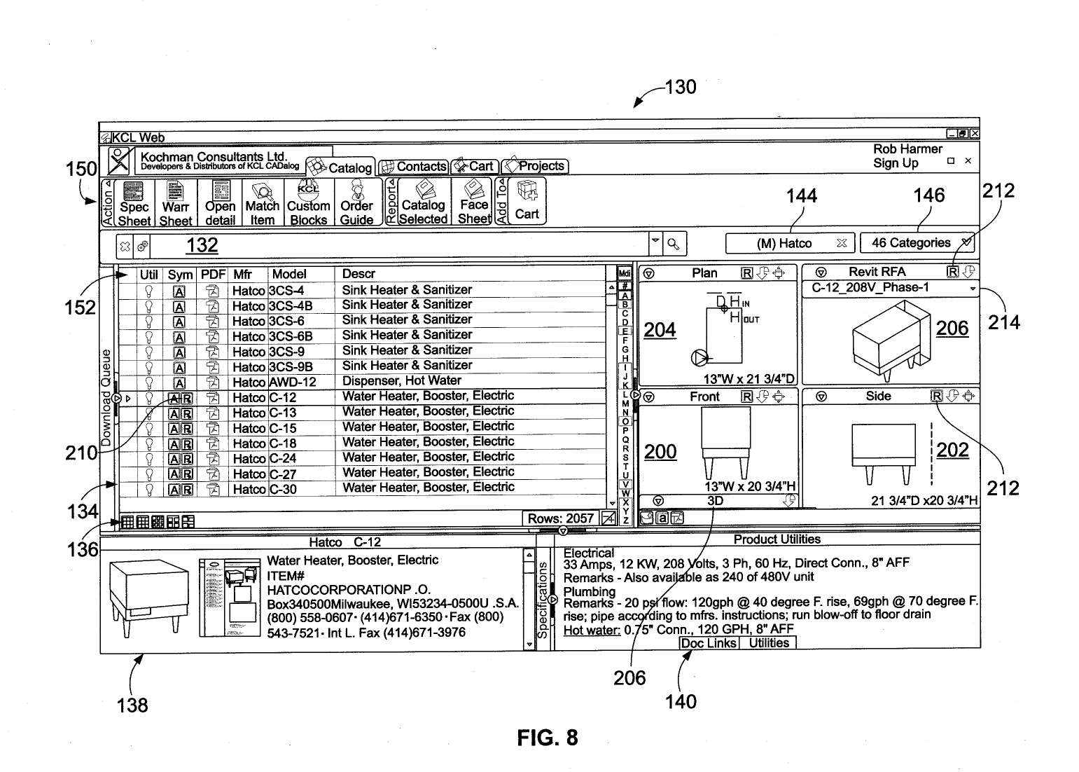

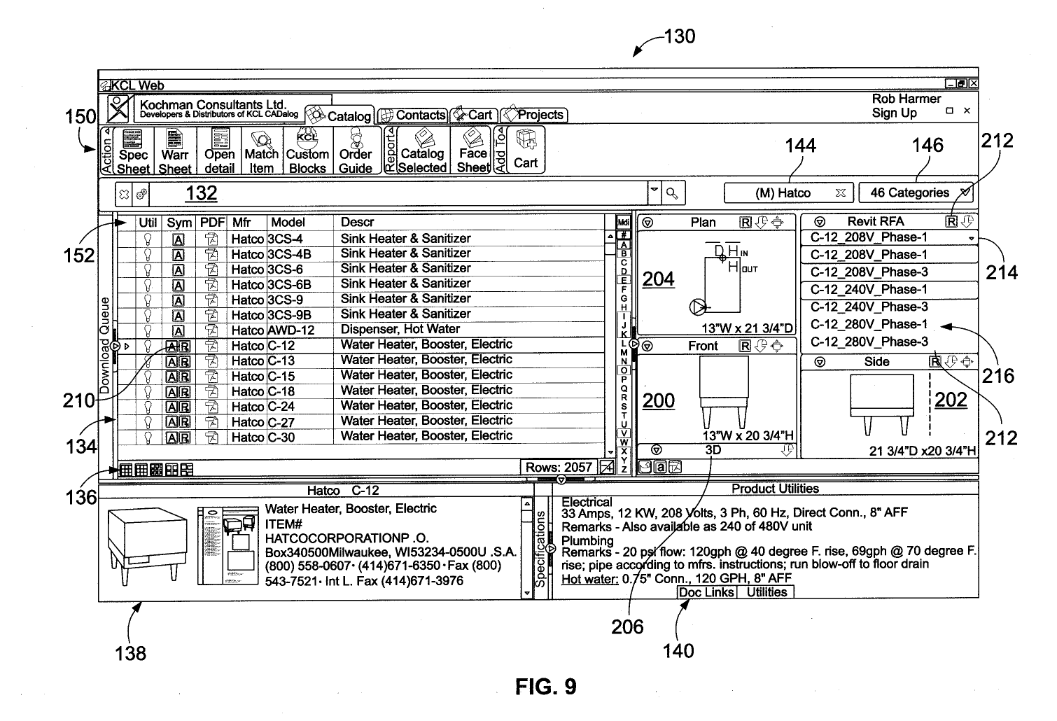

FIG. 8 shows an example of an object having a Revit—Simple Type Catalog file type. Specifically, the object selected here is a Hatco C-12 water heater. With Revit—Simple Type Catalog files, the object import interface 130 is configured to provide, the user drop-down option 214 in the Revit RFA view 206. Once the user clicks the drop-down option 214, the user is presented with various types 216 of objects associated with that particular model number (i.e., C-12), as shown more fully in FIG. 9. The user may then select the desired type such as, for example, a model C-12 water heater operating off 240 Volts and 3 Phases. Therefore, the user only sees the types if he or she wishes to choose a particular type. If the user does not choose to pick a particular type, the “type catalog” of Autodesk Revit Architecture is hidden from the user. The user thus has the option to view the various types of a model before importing the object.

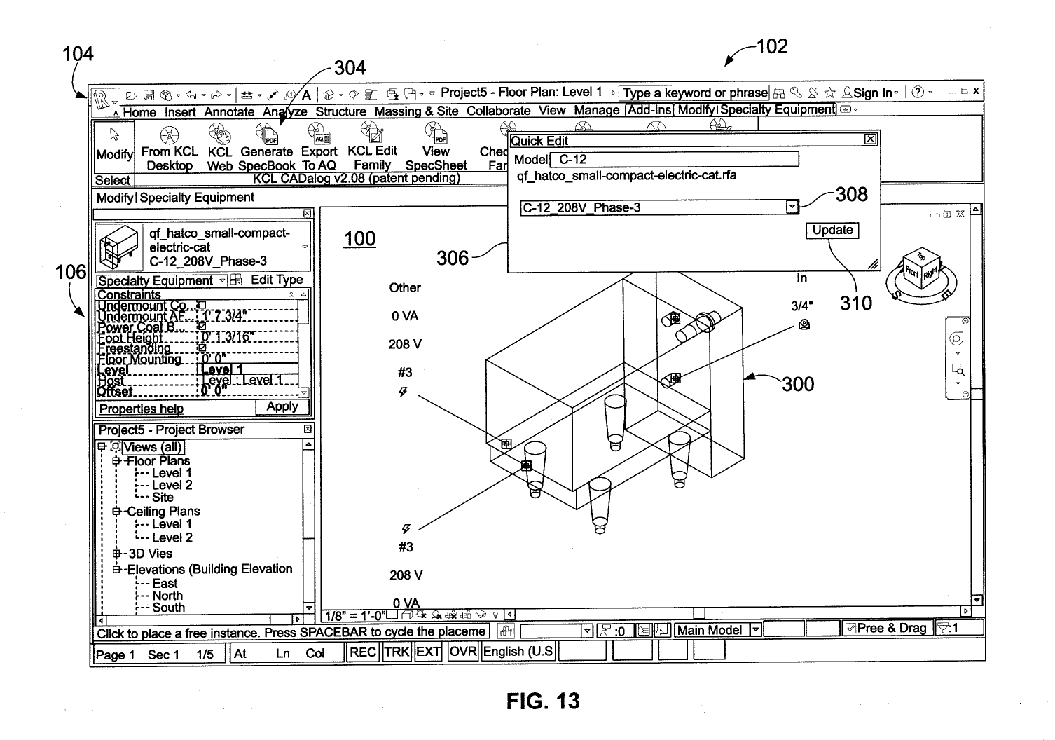

As will be described below with reference to FIG. 13, once an object with this type of file is imported into Autodesk Revit Architecture, the user may quickly and easily change the model to a different type by selecting another feature shown along the Add-In toolbar.

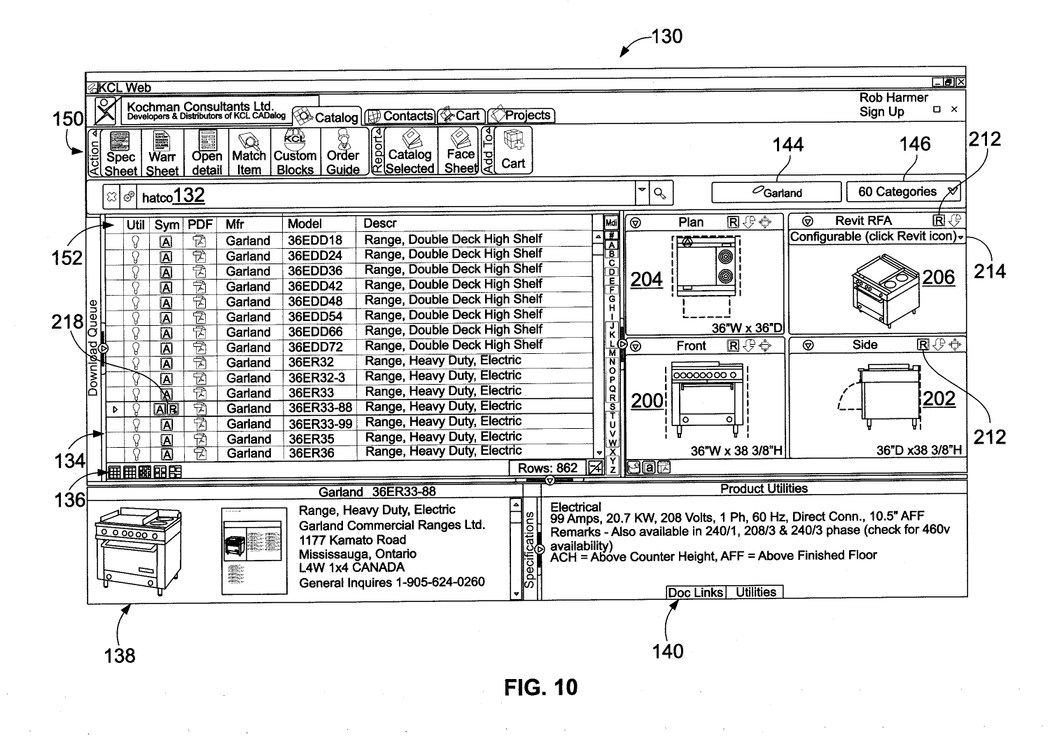

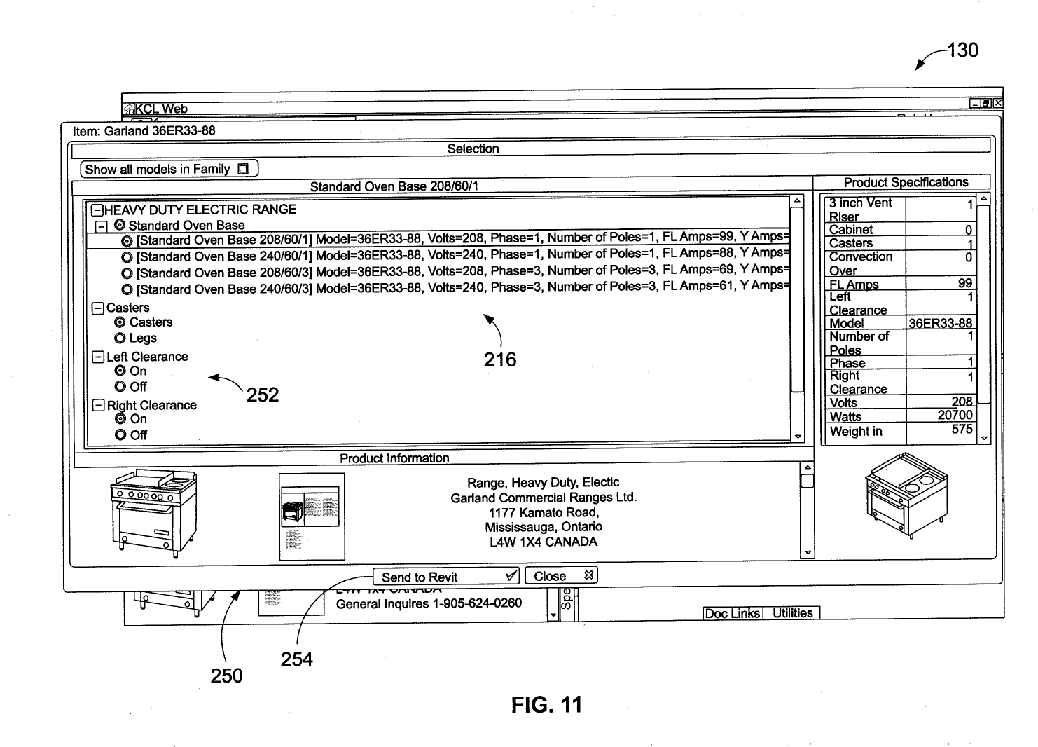

Further yet, FIG. 10 shows an example of an object having a Revit—Configurable file type. Here, a Garland 36ER33-88 heavy duty electric range is selected in the database 134. An “R+” symbol 218 along with the drop-down option 214 indicate that this object is configurable—beyond type as described above with regard to Revit—Simple Type Catalog files. By clicking on any of the “R” icons 212, a configurator 250 will appear, as shown in FIG. 11.

With many types of symbols in a Revit family and a multitude of parameters, it can typically be difficult to select the proper type. For this reason, manufacturers often add comments to an external type catalog. The present invention, though, parses the comments from the actual type. In an alternative embodiment, the comments can be displayed or stored (and later printed) separately for the users convenience. Some parameters have an optional character where the user can select a type and subsequently decide on options such as finish, legs or casters, left or right swing, and so on, for example. The present invention detects these options and presents the user with the configurator 250.

In addition to providing a user with the ability to select types 216 and an ability to read manufacturer comments, the configurator 250 allows the user to select any other options 252 that are configurable, before importing the object into the project. After the user selects options, if at all, the user may select the “Send to Revit” 254 button, which will import the object as specified in the configurator 250.

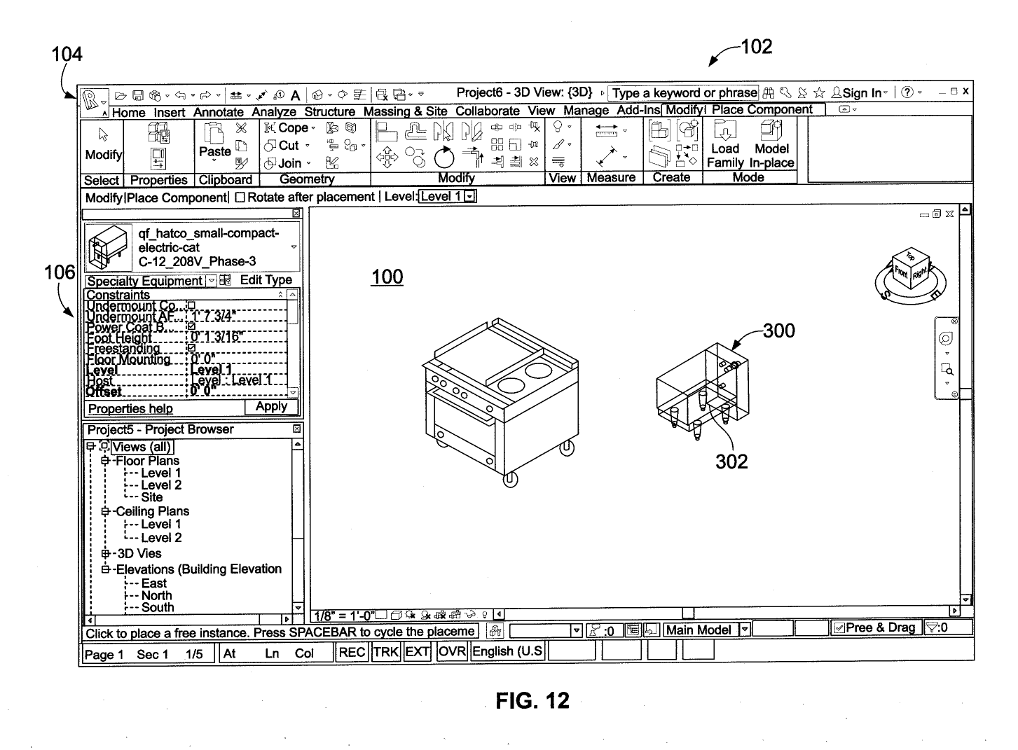

With reference to FIG. 12, once an object is selected for importing, either through the configurator or by clicking one of the “R” icons in the object import interface, the user interface 102 of Autodesk Revit Architecture is returned to the forefront. Without having to click anywhere, an object 300 to be placed within the project 100 may appear on a cursor 302 hovering within the project 100. The user may locate the cursor 302 as desired and place the object 300 within the project 100 by a single click of a mouse or keystroke. In some embodiments, the object 300 may remain on the cursor 302 after placement in case the user wishes to place multiple objects 300 within the project 100. In such embodiments, the user could press the “Spacebar,” “Esc,” or any other key to clear the object 300 from the cursor 302.

Referring now to FIG. 13, the user interface 102 is shown to have the object 300 placed within the project 100. The object 300 in this example is the Hatco C-12 water heater, as described above with reference to FIG. 8. For models that have different type settings, particularly with regard to Revit—Simple Type Catalog and Revit—Configurable file types, the user may modify the type directly within Autodesk Revit Architecture. To do so, the user may select an edit feature 304 from the Add-In toolbar 112, which may bring up a “Quick Edit” toolbox 306. A drop-down box 308 may allow the user to choose another type for the particular model selected. After selecting the modified type, the user may then click an “Update” button 310 to update the object 300.

Another feature that the present invention provides is the ability to check for updates to an object or family of objects, either automatically or manually, while remaining within Autodesk Revit Architecture. This feature, too, can be placed within the Add-In toolbar 112 and is made possible in part because the object is linked back to the database, which is updated routinely. Likewise, the object can be linked to the specification sheets available through the database, or other data or graphic updates stored in the database. One purely exemplary use of this link would be to select all of the objects within a project and generate a file of all the specification sheets for everything in the project.

Still another aspect of the present invention is the option to import single objects as opposed to entire object families. Importing single objects provides the user with more control over the particular object being imported. Plus, the time it takes to import a single object is but a fraction of the time it takes to imports a family of objects. Revit families come in several different packages. For example, Revit families come with either an external type catalog for multiple types, with internal types, or with single types. The present invention eliminates the disadvantages as noted above (e.g., having to load all internal types or having, at times, to reload external types for a single family) in such a way to maximize performance and minimize overhead in resources such as memory usage and disk space, for example.

In another embodiment of the present invention, Autodesk Revit Architecture may be in an improper view for loading a particular object, particularly 2D and 3D AutoCAD files. When this occurs, the object to be imported is put in a queue for placement when an appropriate view is enabled.

Another aspect found within the object import interface 130 is a custom block feature. This feature allows the user to configure hundreds of generic symbols. For example, the user may configure the width, height, depth, or the like before importing an object into the project.

A still further aspect of the present invention is the ability to add one or more parameters to an object.

The exemplary system shown in the figures and described above can also be said to illustrate a method for importing objects into CAD programs. To avoid redundancy, however, the system will not be completely re-described in terms of a method. One skilled in the art would understand how the system, shown through the figures and described above, would be equally applicable to the method for efficiently importing objects into CAD programs.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method of importing digital objects into a computer-aided design (CAD) program, the method comprising:
selecting an import feature within a user interface of the CAD program;
selecting a digital object from a database of digital objects presented within an object import interface, with the database comprising a compilation of digital objects collected from a plurality of external sources; and
placing the selected digital object within a project shown in the user interface of the CAD program by a single click or keystroke,
wherein the database allows for the digital objects to be sorted according to at least one of the following criteria: manufacturer, category of digital object, file type, and model number.

2. The method of claim 1 comprising a further step of choosing a type of the selected digital object before placing the selected object within the user interface of the CAD program.

3. The method of claim 1 comprising a further step of configuring one or more options for the selected digital object before placing the selected object within the user interface of the CAD program.
